(19) United States
(12) Patent Application Publication
(10) Pub. No.: US 2010/0138481 A1
(43) Pub. Date: Jun. 3, 2010

(54) DEVICE AND METHOD FOR ESTABLISHING SOCIAL NETWORKS THROUGH THE USE OF WIRELESS TECHNOLOGY

(76) Inventor: Philip Behrens, Sperryville, VA (US)

Correspondence Address: Philip Behrens, 1419 37th Str. NW, Washington, DC, 20007, US

(21) Appl. No.: 12/598,425

(22) PCT Filed: Apr. 30, 2008
(86) PCT No.: PCT/EP08/55394

§ 371 Date: Oct. 30, 2009

Related U.S. Application Data
(60) Provisional application No. 61/024,794, filed on Jan. 30, 2008.

(30) Foreign Application Priority Data
Apr. 30, 2007 (DE) 10 2007 020 296.4

(51) Int. Cl. G06F 15/173; G06F 15/16

(52) U.S. Cl. 709/203; 709/224

(57) ABSTRACT

The invention relates to a portable electronic device, comprising means (c) for scanning continuously/repeatedly for UIDs sent out by other devices and recording these UIDs in a log; and means (d) for transferring the recorded UIDs to a server or another device (f);
and to a method for establishing-server-based communication options, whereby:
(a) portable electronic devices containing identifiers (UIDs) record identifiers that are transmitted wirelessly and non-directionally by other portable electronic devices,
(b) the identifiers (UIDs) are transferred to a server, and
(c) the identifiers (UIDs) are used by a server to provide communication between users of the devices containing the identifiers that have been recorded.

Moreover, the invention relates to a device and method for establishing contact wirelessly with a second compatible device, where the device comprises
means (a) for automatically establishing non-directional contact as well as the transfer of one or more first data packets between the device and one or more target device(s); and
means (b), which (following an automatic, non-directional contact as well as the transfer of one or more first data packets between the device and one or more target devices) allows the user to transfer one or more directional second data packets.

The invention relates to a device and method for establishing contact electronically through the use of wireless technology. More particularly, the invention relates to a device and a method through which contact is automatically established between users who come into proximity of one another.

### BACKGROUND

In this day and age, mobile phones have become an integral part of the daily lives of hundreds of millions of people. Electronic messaging such as SMS (short messaging service) or E-Mail through the use of mobile devices is also becoming increasingly common, particularly among younger people. However, the exchange of personal contact information, which is required for establishing electronic communication (telephone, SMS, instant messaging, e-mail) occurs largely in conventional, non-electronic manner. Phone numbers as well as electronic addresses are often still communicated verbally or on paper. At times, a cell phone will be handed to the person with whom such contact is desired, in order to let that person enter his own number or e-address. An exception is the ability of some mobile devices to transmit electronic business cards to compatible devices, using infrared or Bluetooth transmission, for example. Internet forums provide a means to establish contacts electronically. However, these are accessed through the help of computers and are bound to Internet portals.

Sharing one's personal phone number or e-mail address with someone usually represents a step which cannot be reversed very easily. Therefore, most people think twice before giving out their personal contact information to strangers, often preferring to get acquainted a bit first. Moreover, it is normally not possible to contact strangers through mobile devices, since one would not have the coordinates for doing so. Current electronic communication systems thus do not offer a viable alternative to approaching strangers in person.

It has, for some time been possible to make acquaintances using various forms of Internet-based communication. Countless Internet services offer to bring users into contact with one another based on a variety of criteria, such as, for example, common interests, gender, age, regional location, as well as combinations thereof. Examples include Internet forums, messaging boards and online dating services.

In recent years, emerging online social network websites have focused on allowing users to build their own individual online social networks by adding known friends or acquaintances to their own personal profiles or user accounts. This is typically achieved through users searching for names of friends who may already have registered with the service. If a friend is not yet a member of that service, the user may disclose that person's e-mail address to let the service contact that person. The service then sends an e-mail to the person, asking whether he or she would like to join the service as well as the initiating user's friend list. By displaying, more or less openly, users' friendlist to others, many of these services also encourage their users to contact their friends' friends. This can lead to rapidly growing friendlists. In some cases, it has even resulted in users attaining hundreds and even thousands of “friendships” on such a site. As a measure of preventing this kind of “friendship inflation”, some services implement access filters, proposing friendships more in accordance to common interests, age or user locality. This can lead to more meaningful friendlists.

A growing concern on social networking sites has been the misuse for purposes of delivering unsolicited communication (spam) for commercial, personal or criminal purposes.

An object of the present invention is therefore to provide a device and a method through which users may come into electronic contact with one another on the basis of their individual, dynamic localities. A further object of the present invention is to use wireless technology for providing special communication layers through the help of which users may come into contact with one another on the basis of past and/or present proximities in relation to one another. Said communication layers are also intended to provide an alternative to the disclosure of personal contact information that is typically required for electronic communication. Such a communication layer may be viewed as a kind of sand box for generally open and unrestricted communication, which may also be shielded from the other functions provided by the devices.

In a first aspect, the present invention therefore provides a device for establishing contact wirelessly with a second compatible device, comprising:

Means (a), for automatically establishing non-directional contact as well as the transfer of one or more first data packets between the device and one or more target device(s); and

Means (b), which (following an automatic, non-directional contact as well as the transfer of one or more first data packets between the device and one or more target devices) allows the user to transfer one or more directional second data packets.

According to the present invention, “automatically establishing non-directional contact” is to mean that the user does not specify with which device(s) a contact is to be made, but rather that all receptive devices are addressed, similar to a radio broadcast. In this context, the term “contact” merely describes an active connection between the device and at least one target device, regardless of the duration thereof. Specifically, the reception of non-directional, first data packets does not require a response by a receiving device. The device may also be adjusted in such a way that a search for receptive devices (within range) is conducted automatically and that contact is established automatically, or that such receptivity is to be induced by the user.

According to the invention, “automatically establishing non-directional contact as well as the transfer of one or more first data packets” is to mean that the user may allocate or furnish specific information (e.g. photo, logo, sound, video) for establishing a first contact via first data packets; thereby not specifying which devices are to receive this data.

Herein, no specific distinction is made between the terms “data” and “data packets”.

Therefore, through means of the inventive device according to the first aspect, contact may be established with at least one target device. In general, the target device will be a compatible device of another user with whom a contact could or should occur. Both the device and the target device may be mobile phones or other types of electronic devices.

The term “target device” is herein used to refer to a further inventive device, or a device that is compatible with the inventive device. It is further used to indicate such a device carried by a third user.

The term “third user” is used herein to indicate a further user.

In general, the means (a), and (b) are capable of transmitting as well as receiving electromagnetic radiation on one or more frequencies. This frequency or these frequencies may, in general, differ from those typically used in mobile phones and other portable electronic devices, such as GSM, UMTS, Bluetooth and WLAN.

Preferably, one or more frequencies in one of the license-free ISM-bands are used (e.g. 2400 MHz to 2500 MHz or 433.05 MHz to 434.79 MHz). Frequency-hopping techniques can serve to prevent interference, such as that resulting from other devices using the same frequency ranges. Furthermore, checksum verification and/or encryption may be employed to maintain data integrity.

An established contact may be displayed or signaled on the inventive device, and, if applicable, on the target device. This can specifically include optical, acoustic or mechanical signals, such as vibration mechanisms.

The automatic establishment of contact through means (a) may be initiated by the user, or it may be established automatically, subject to settings or pre-adjustments on the device. This concerns one or more targeted first data packets. Once a contact is established between the inventive device and at least one target device (i.e. the devices are able to “see” one another), data may be exchanged.

Preferably, the inventive device comprises an electronic component wherein the means (a) and (b) are contained. According to the invention, this means that a connection between the said electronic component, and the rest of the device exists, at least temporarily. Specifically, the said electronic component can be integrated in the device, attached to the remainder of the device (by means of a plug or cable connection), or it may be connected wirelessly to the remainder of the device.

The means (a) are preferably equipped in such a way that a detection of the presence of at least one target device within a minimum and/or maximum distance is made possible. Specifically, the means (a) can be set in such a way that a minimum and/or maximum distance between the device and at least one target device may be selected, and within which establishing a contact is possible. This distance can vary greatly. In general, the distance will not be more than 5 km. Preferably, the maximum distance will be 1 km. More preferable is a distance of 100 m. In an especially preferred embodiment, this distance will be 50 m and, even more so, 20 m.

The maximum distance can be adjusted through predefined signal strengths of the electromagnetic radiation, for example. Such a setting may also be influenced through software. By using software, further information can be taken into account. This can include information relating to the geographical location of the devices, derived from additional means including GPS, for example.

In an especially preferred embodiment of the first aspect, the inventive device comprises means (c) for determining its own location. It is preferred, that the means (a) are able to determine the distance between the device and a target device, the location of which may be ascertained.

Preferably, the inventive device has an identifier (ID), which can be transferred to at least one target device. This identifier contains information for identifying the device (and thus its user).

Preferably, the identifier is unique, especially to each device of its type, and unchangeable. The identifier may stem from the serial number of the electronic component, for example. In general, the identifier allows the device to recognize another device as well as to specifically respond to another device (or its user). The identifier also serves to allow the user of such a device or target device to block out other users from his device, in order to stop the other user from further contacting him, for example. Blocked identifiers are preferably stored on the device (the one that should block out the other). This allows users to demarcate, or mark themselves off, in what is generally intended to be an open, uncontrolled and unrestricted setup.

In general, the identifier is either transmitted simultaneously with the first data packets, or before.

In a preferred embodiment of the first aspect, the inventive device can store the identifier, and/or further data, from one or more target devices. Preferably, the inventive device allows a transfer of this information onto external storage. The device identifier contains information for identifying the device.

The device can be equipped in such a way that first and second data packets may only be transferred after reception of the identifier and, if applicable, verification thereof.

According to settings on the inventive and target devices, second data packets that have been selected or furnished by the respective users may be transferred in one or both directions. Also possible is the directional communication between three and more devices.

Preferably, the means (a) and (b) permit controlling the content of data and/or the transmission of data to the at least one target device by the user.

This data, especially in the form of first data packets, may include pictures, text, logos, videos, sounds as well as live video signals (e.g. from a camera built into the mobile device). Furthermore, the first data packets can include questions or messages that have been prepared or structured by software. These can serve to address common interests, specific questions or other information. In general, such information will be transferred to the target device, where it may be answered manually or automatically. Such a reply can be made subject to settings on the target device or to profiles containing information pertaining to pre-configured answers or responses, for example.

Moreover, the exchange of data may be processed and structured in accordance with filters. Preferably, such filters are implemented and configurable through software.

Preferably, the user of the inventive device may, at any time, view or scroll through received data from other devices/users. He may decide which data he wishes to keep or delete.

Preferably, the inventive device is able to display (or notify) whether another device, of which it has previously stored the identifier and possibly received other data from, is within its range (therefore has reentered its range). Preferably, a required proximity may be specified or predefined for this. The display or notification can be an optical, acoustic or mechanical signal, for example. If so desired, the user of the inventive device may transmit further contact information. This could, for example, include a phone number, mobile phone number, e-mail or instant messaging address. Once again, this contact information may be accepted or blocked by the receiver.

Transferred data (received and/or sent) may be stored by the devices involved for a predefined period of time.

More specifically, data which has been transferred automatically (without active involvement by the user) may remain stored on the device. This may be governed by settings which are selected by the user, or be made dependent on the device's storage capacity.

If so desired by the user, the device can memorize another device solely on the basis of the other device's identifier. Therefore, communication is in principle possible on the basis of the inventive device-specific frequency, and without an exchange of further contact data, so long as the devices are in range of one another.

In a second aspect, the invention also relates to a method for establishing contact wirelessly between the inventive device and at least one target device, whereby:

means (a) automatically establish non-directional contact as well as transfer one or more first data packets between the device and one or more target device(s), and

means (b) (after automatically and non-directionally establishing contact and transferring one or more first data packets between the device and one or more target device(s)) transfer one or more second data packets, directed and controllable by the user of the device.

Several preferred and non-limiting embodiments are described in the following.

According to the second aspect of the invention, the device sends out non-directional first data packets, preferably compressed, at specific intervals (e.g. milliseconds to several seconds). These first data packets may contain a content-type of information (e.g. text, photos, logos, video or live video signals) which has been predefined by the user, in general along with the device's own identifier.

If he so desires, a user who has received such non-directed first data packets (generally together with the sender's identifier), may actively contact the person whom he has received these first data packets from. The following non-limiting embodiments are applicable in such a case.

In a first embodiment of the first aspect, a device according to the invention transmits second data packets (through which the third user wishes to make contact) using the same frequency and encryption level that were used for the undirected transmittal of the first data packets and the identifier. In this case, the identifier of the device or target device are included in the second data packets. In such a case, the inventive devices can be programmed in such a way that they are able to verify the identifiers enclosed in data packets and to ignore data addressed to a different identifier than its own. In this context, the term “ignore” means that the data is either not stored or deleted.

A second embodiment of the first aspect differs from the first in that additional encryption is used. This can involve the identifier of the receiving device for encrypting the second data packets. In such a case, the involved devices should be capable of encrypting directional data packets in such a way that the data will be decrypted only by the device with the corresponding recipient identifier.

In a third embodiment of the first aspect, the inventive device sends the directional data packets using a different frequency. Directional data packets will therefore be transmitted on different frequencies than non-directional data packets. Encryption may be used independently thereof.

In a fourth embodiment of the first aspect, the inventive device transmits the directional data packets using a different transmission path than that which is used for non-directional data packets. This could include Bluetooth or Wireless LAN (ad-hoc mode), for example. In such a case, the recipient can accept the second data packets in accordance with any security measures of the used transmission path.

In a fifth embodiment of the first aspect, the inventive device transmits the second data packets via an Internet portal which has been configured accordingly. While this could require that the inventive devices be connected to the Internet, the online portal could also redirect such communication through different types of connections, including SMS or MMS, for example.

In a sixth embodiment of the first aspect, the inventive device transmits the second data packets via communication paths which are typically operated by mobile phone carriers. In this case, the carrier provides a connection through which the second data packets are transmitted (in accordance to the recipient's approval).

There can be combinations of these non-limiting embodiments as well.

A common factor of all inventive devices and methods presented here lies in their ability to provide a means for communication to occur, independently of, and without requiring, the user's personal contact data. This allows a user to be in contact with a third person for as long (and only as long) as he wishes to. In general, the identifiers are used for this purpose; the device provides a way to block unwanted identifiers, thereby preventing unwanted communication at any time.

In a third aspect, the present invention provides a portable electronic device, comprising
means (c) for scanning continuously/repeatedly for UIDs sent out by other devices and recording these UIDs in a log; and
means (d) for transferring the recorded UIDs to a server.

These means can be in the form of software and/or hardware.

Electronic devices according to the third aspect thus continuously/repeatedly transmit unique identifiers (UID) via non-directed wireless radio frequency transmission. Devices that are equipped with the means provided by the third aspect of the invention may scan continuously/repeatedly for UIDs transmitted by other devices within range.

In a preferred embodiment of the present invention, the device contains means (e) for transmitting continuously/repeatedly one or more unique identifiers (UID) via non directional wireless radio frequency signals.

When such a device receives another device's UID, it records that UID and measures the length of time during which it continues to receive that UID. The device stores the received UID, along with the time, date and duration of the reception. It stores this information in what shall herein be referred to as a “seen log”. A device's seen log will contain information regarding which UIDs have been received (or “seen”) by the device. It may also contain information regarding when and for how long a UID will have been received.

The following definitions are used in the present invention:

Unique identifier (UID): A code, number, address or other symbol that uniquely identifies an AC device, and, by association, the owner of the AC device. Specifically in regard to the third aspect of the invention, a UID may consist of or include a MAC (media access control) address, Bluetooth Device Address (i.e. BD_ADDR), or other unique or quasi-unique identifier. In general, it may be hardware-bound and unchangeable, as well as software-based and possibly modifiable by the user.

Seen log: A log representing receptions of UIDs. May include information related to UID receptions, such as, for example, time, date, duration and location of UID receptions. May also include further information, or links thereto, such as those related to UID receptions, or those possibly deemed relevant by a user. A seen log may specifically include information pertaining to spatial locations of UID receptions. Furthermore, a seen log may include any form of information stemming from user input, such as to mark specific events, for example.

Seen list: A list containing more or less processed, interpreted, and/or structured information stemming from one or more seen log(s). The information contained in a seen list may be linked, combined or otherwise put into relation with friend lists, such as, for example, those used by online social networking sites. A seen list may also reflect information and/or choices from users, and could be modifiable by users. Seen lists may provide information in a variety of ways, including personal and/or customized information for individual users. It may also include information to be displayed to specific groups of users, as well information that may be made accessible to anyone.

Claimed UIDs and unclaimed UIDs: UIDs which have been linked to user accounts may herein be referred to as “claimed UIDs”, while those that have not may be referred to as “unclaimed UIDs”.

UID account: The term “UID account” may also be used herein to describe a kind of online user account that has been linked to a given UID by the server. The server may receive such a UID (to be able to link it) as contained in another device's seen log or through a user supplying his device's UID to it (the server).

Unclaimed account: A user account which is generated on the basis of an unclaimed UID may herein be referred to as an “unclaimed account”.

Associate: The term “associate” is used herein to indicate an association of two or more UIDs and thereby the corresponding device users through server-based user accounts. Such associations may, for example, be used for providing server-based communication or options there for, including social networking or messaging functions.

Generally, a device's seen log will represent information pertaining to which devices have come into range of the used wireless transmission, as well as when and how often.

According to a preferred embodiment, the device of the third aspect of the invention may also store information regarding its location at the time of a UID reception. Such information may be obtained from any available source, including Cell-IDs from mobile network operators, position determining equipment using Cell ID techniques, U-TDOA, A-GPS, E-CID, AOA, standard global positioning system equipment (GPS), WLAN access point based positioning, etc.

Information regarding the device's location at the time of a UID reception may also include or be derived from any form of user input, such as through key or touch-screen entries, “gestures”, device movements (e.g. via accelerometer), vocal input, etc.

According to the invention, the device may also store further information relating to the reception of a UID, and specifically information relating to the time, date and/or locality of a UID reception. The device preferably stores this information in a manner that links the information to events recorded in the seen log. Preferably, this manner can include some form of user input, perhaps marking a particular point in time. This can also include the storing of photos, video and/or audio material. Furthermore, it may also include information regarding phone calls, messaging or Internet activity, which may stand in some relation to events stored in the seen log.

The term “server” may herein be substituted for “online service”, indicating Internet-based services which are provided to the users, or potential users.

According to a preferred embodiment of the third aspect of the invention, the device provides its seen log information to a server, along with its own UID. This may occur via any kind of data-capable connection, including GSM, GPRS, UMTS, LAN or Wireless LAN, for example. It may occur in any form, including a direct, single-purpose upload, or bundled with other data, or in combination with other electronic transfers, such as e-mail, SMS, MMS, etc. Furthermore, the device may also transfer the seen log information to other electronic devices, such as personal computers, for example, which, in turn, can upload or forward the said information to a server. Devices may also distribute seen log information in a peer-to-peer (P2P) fashion. Accordingly, any other computing device, including a personal computer, may assume, in part or entirely, the functions of the server. In the case that P2P is used, the devices may handle the server's processing function described herein in a decentralized fashion.

According to embodiments of the invention, once such seen log information is received by the server, the server may store the information in a manner that is linked to the corresponding device's UID. Preferably, the server analyzes and further processes the seen log information.

In general, each UID corresponds to one user account. However, a UID may also be linked to more than one user account, such as through different servers or online services. A user account, in turn, may also be linked to more than one UID. Furthermore, a UID may correspond to separate user accounts on different servers or online services.

The server preferably associates or links a user account to every UID it receives. The server may link UIDs in various ways. For example, a user may connect to the server through a web browser to supply his device's UID in order to open (create) a new user account, or to append an existing one. In such a case, the device to be used (having the UID) will not need to connect to the server for this part of the process.

There are various ways a user may obtain his device's UID. For example, he may be able to access this information directly on his device. As such, many cell phones produced by the Nokia company will display such information if the user enters a special code directly on the device (“*#2820#” for BD_ADDR or “*#62209526#” for WLAN MAC Addresses). An additional, separate device may also be used to access a device's UID. This could include a computer, PDA, or cell phone, for example. In certain cases, manufacturers will also provide the information in the form of a sticker on the device or manual.

In a preferred embodiment, the server automatically generates new user accounts for any unclaimed UIDs that it receives. The server may receive such (unclaimed) UIDs contained in uploaded seen logs, for example.

A user account which is generated on the basis of an unclaimed UID may herein be referred to as an “unclaimed account”.

The user of a device may herein be referred to as the “user” of an unclaimed UID, although he has not actually “used” it. Likewise, a user may herein be referred to as the user of an unclaimed account.

Generally, certain functions described herein do not require a user to have personalized, or even accessed, his device's corresponding user account.

For example, an unclaimed UID may be recorded and uploaded by other devices as well as processed accordingly by the server.

For such cases, the server may display a generic placeholder as well as further (possibly random) data, to symbolize the corresponding user. This may help users visualize such a user, and may also include information derived from the seen logs (e.g. times, dates, locations, etc).

Consequently, users may also attempt to communicate with the user of an unclaimed account. In such a cases, the server could save (in a way that is linked to the unclaimed account) any messages and/or information regarding the communication attempt. Such information could then be made available (by the server) to the user once the account is claimed.

Generally, the server analyses the seen logs and provides options for communication on the basis of UIDs which have been transferred between devices. The server may compile what will herein be referred to as “seen lists”. In general, a “seen list” represents information regarding persons whose devices have come into proximity of a given user's device. Furthermore, the seen list can reflect information regarding the lengths, number and frequencies of meetings between users. The server may also structure or rank the seen log information to structure seen lists according to whom users have been near most often and/or near for the longest durations, for example. The server may also compile customized displays of this information according to one or more optional choices by the user. This may be useful in case a user wishes to know whom he has been near on a particular day, time, and/or at a particular location. Further information such as filters for determining compatibilities between users may be used in conjunction with this.

In general, seen lists may take on any form of human comprehensible depiction or interpretation, including text, descriptions, images, photos, video, sounds, logos, 3 dimensional graphic displays, avatars, etc.

Once a user accesses his device UID's online user account, he may choose to personalize it such as through a personal profile. He may do so by adding more or less personal information, photos, videos, logos or any other type of data. He may also choose not to reveal any personal information for his user account.

Such user accounts containing a photo, video, logo, nickname or description may be useful in allowing others to recognize the users they have been close to (spatially). In such cases, selective electronic communication becomes possible between those users who have stepped into physical proximities of one another. However, even in cases where a user account does not contain or display any telling information, the seen lists by their structure alone may reveal enough indications for users to be able to determine whom they may want to attempt to contact.

By analyzing a given log, the server can associate two or more devices, the UIDs of which have been recorded therein. For example, if a first device's seen log contains two devices' UIDs (other than its own), the server may create three different associations: one between the first and the second device, a second one between the first and the third device, and a third one between the second and the third device. In other words, the server may (indirectly) associate the second and the third device, solely on the basis of their UIDs being present in the first device's seen log. By deductive logic, a mutual presence in the first device's seen log indicates that these two devices may also have come into proximity of one another. By analyzing the seen log, the server may also take into account information in regard to times, dates and/or locations of events. For example, such information in a seen log may indicate that the said second and third devices both came into the proximity of the first device, perhaps within a certain time span in relation to one another or at a common or related location. The information may also reveal more general information, such as that the second and third device users appear to be in the same city or neighborhood, for example.

Furthermore, even if the seen log reveals that the two devices may not have come into proximity of one another, their users may still share an interest in being associated online (through a kind of implied association).

Several advantages arise out of this procedure of associating two or more UIDs on the basis of a third device's seen log information. Firstly, it can mean that not all devices are required to record seen logs in order for their users to take advantage of the server-based functionality provided through the invention. This can be helpful in instances where a portion of the devices (of users who wish to use the said functionality) do not possess the required hardware of software for executing such actions themselves, for example. Furthermore, some devices may be capable of executing such software, but their users may not wish to install/use it (or know how to). Therefore, this procedure may allow the invention to be of use with only a portion of the devices being equipped to actively record seen log information. Accordingly, if a first device sends out its UID, and that UID is recorded in a second device's seen log, the user of the first device may benefit from the described functionality just like the second device's user, by being mutually associated online. The server may associate such a user to any other users whom he comes into proximity of, be it directly or indirectly (via a third user). The associations may even span over more than one user who was commonly “seen”.

In the devices according to the first and third aspect as well as in the device used according to the second aspect, contact is established in a wireless manner. The present invention thus relates in particular aspects to the use of short-range or medium-range radio frequency technology as means of managing server-assisted online social networks. It thereby proposes to group or link together potentially interested persons by determining which users have come into physical proximity of one another.

Currently, a growing percentage of portable electronic devices are capable of short-range wireless communication. More specifically, this category of devices can include cellular phones, personal digital assistants, portable MP3 players, e-book devices, digital cameras and portable gaming devices. It also includes portable computers such as laptop computers, ultra-mobile PCs, etc.

A currently well-established standard for short-range radio frequency technology is Bluetooth. It is often used to establish ad-hoc connections between two portable devices, for example. It may also be used to establish connections between portable devices and accessories, such as wireless headsets or alternative input devices, for example. As such, Bluetooth has found its way into an ever growing number of electronic devices. It may currently be regarded as the most established short-range wireless standard for use in mobile phones, smart phones and personal digital assistants.

A further example for short-range radio frequency standards may to be found in the ZigBee specification, for example.

Medium-range radio frequency technologies include those used for wireless local area network (WLAN) communications. WLAN may be used both for infrastructure-based networks, as well as for ad-hoc (peer-to-peer) connections between devices.

According to a preferred embodiment of the third aspect of the invention, portable electronic devices send out via non-directional, short-range and/or medium-range radio frequency transmission, at least one unique identifier (UID) continuously or repeatedly, generally at a variable interval. This UID may consist of any unique or quasi-unique code, number, address, symbol, or a combination thereof, which uniquely identifies a device, and, by association, the owner of the device. Furthermore, existing networking addresses, such as media access control addresses (MAC addresses) or Bluetooth Device Addresses may be used. In the case of Bluetooth, various address parts and lengths (e.g. 48-bit BD_ADDR, 24-bit LAP, etc.), Friendly Names, as well as a combination thereof may be used.

According to the third aspect of the invention, the portable electronic device scans for UIDs sent out, preferably via short-range and/or medium-range radio frequency transmission. Upon receiving a UID, the device stores the UID. The device may also measure the length of time during which it continues to receive that UID. Generally, the device stores information regarding the length of reception in a log called a “seen log”.

In order to compensate for interruptions in the reception of a UID (e.g. from inconsistent wireless receptions), the device may join together any resulting segmented entries in its seen log, such as within a variable time-span, for example. In other words, if a received UID is not received during a certain period of time (such as for a few seconds or even minutes, for example), followed by a renewed reception of the same UID, the receiving device may store (or modify) the event in its seen log as if the interruption had not occurred. Alternatively, this type of processing of the seen logs (to fill gaps in transmissions) may also be handled by the server. This may, for example, allow a lower processing workload on the mobile device. Server based processing may also allow for more options and for customization of seen lists. Additionally, interruptions of UID receptions may indicate a larger distance between the devices involved and as such, provide useful information in the evaluation of the seen logs.

In general, a device may scan for (and record) more than one device simultaneously. For example, it may continue scanning for receivable UIDs, while performing the described measuring (length of UID receptions) and storing (to seen log) functions. This may be useful when several devices are in range simultaneously.

In general, the device according to the third aspect of the invention may receive instruction to ignore specific UIDs. Furthermore, the device may store UIDs to be ignored in a blacklist. Through the user account, a user may also instruct the server to ignore specific UIDs. The user may also tell the server to block specific UIDs, or to have the server instruct his portable device to ignore specific UIDs and vice versa. This may be realized via the user's user account.

In general, one or more devices may receive (from the server) instructions for ignoring specific UIDs. They may also receive instructions for ignoring an entire type or range of UIDs. Such UIDs, which are to be ignored, may be stored in the form of blacklists on the server as well as on the devices.

In general, the function of sending out UIDs may be considered and implemented as an optional mode. Depending on his device, the user may be able to turn this mode on or off. The user may also exercise control over which or how many UIDs are transmitted by his device via short-range or medium-range radio frequency transmission.

In general, the function of scanning for UIDs sent out by other devices is to be an optional mode. The user can turn this mode on or off.

Generally, this aspect of the invention may be incorporated into virtually any portable or wearable electronic device meeting the stated technical requirements. This includes, for example, existing electronic devices such as mobile cellular telephones, smart phones, personal digital assistants, portable MP3 players, portable game consoles, portable electronic book devices, laptop computers, ultra-mobile PCs, etc.

The invention may also be incorporated into a device manufactured specifically for the purpose of the invention. In such an embodiment, the inventive device may comprise a small, battery-powered handheld device, and, preferably, the components necessary for sending out, via short-range and/or medium-range radio frequency, at least one UID. It is preferably equipped with the components necessary to scan for and receive via short-range and/or medium-range radio frequency, the UIDs sent out by other devices. Preferably, it also has memory, which may be FLASH memory, for example. It may have a real-time clock (RTC) or other component for determining the time and date. It may also have some positioning determining component. It has at least one microprocessor for managing the wireless radio transmissions as well as for processing and storing data. Furthermore, it may be equipped with a port for connecting to a computer, such as a USB port, for example. Alternatively, short-range and/or medium-range radio frequency transmission components may also serve to connect to a computer, in which case, the USB port may be done without.

The present invention provides as a fourth aspect a method for establishing server-based communication options, whereby:

(a) portable electronic devices containing identifiers (UIDs) record identifiers that are transmitted wirelessly and non-directionally by other portable electronic devices,

(b) the identifiers (UIDs) are transferred to a server, and

(c) the identifiers (UIDs) are used by a server to provide communication between users of the devices containing the identifiers that have been recorded.

Preferably, in the method of the fourth aspect, the identifiers include Bluetooth Device Addresses, portions thereof and/or Bluetooth Friendly Names. Alternatively, the identifiers may include WLAN MAC addresses.

In a preferred embodiment of the method according to the fourth aspect, a server structures the data received from the device(s) in the form of “seen lists”.

Preferably, the method involves that the recorded identifiers are transferred to a server either by way of another device (such as a computer with Internet access), or via a direct data connections (e.g. GSM, UMTS, etc.).

In one embodiment of the method of the fourth aspect, the recorded identifiers are transferred to a server by the recording device.

In a preferred embodiment, a device used for recording seen logs is a portable device such as a cell phone running special software with instructions for allowing it to scan for UIDs sent out by short or medium range wireless transmission and recording these into a seen log. Furthermore, the software may also allow the device to transfer the seen logs to a server. This could include uploading the seen log information directly to the server via any available connection such as GSM, UMTS, or WLAN, for example. In such a case, the upload might occur periodically or constantly (according to the user and/or predefined settings), such as through an always-on data connection. In case of the latter, the seen logs might consist of only single events (as opposed to an accumulation of entries). The software could also, however, contain instructions for transferring the seen logs to the server via another device (e.g. computer, PDA, cell phone), which in turn can upload the seen log information. The software may instruct the device for sending out a UID via short or medium range wireless transmission. The software may obtain the device's own UID(s), such as the device's Bluetooth Device Address or WLAN MAC address, for example. The software may also, however, assign (or allow the user to assign) a UID. Even in the event that the device has a UIDs, the software may allow use of a different UID. To avoid multiple instances of the same UID, the UID could be longer than conventional UIDs (over 48 bit, for example). The UID could also be checked online (via the server, for example). Consequently, the server would in such cases receive and link the device's seen log in a way that is linked to a different UID than the one possibly sent out be the device. In certain instances, this may be beneficial to the user. This may even allow a user to have multiple or changing UIDs and, therefore, different online identities. A user might thus create a new online identity for an event or party he attends or has attended. Such multiple UID accounts may also be linked to a single user account, where the user could be able to manage these.

In a further embodiment, the device used for recording seen logs may essentially be a single-purpose device. The technical requirements for such a device can be comparatively low when compared to wireless devices such as cell phones or PDAs. This device is equipped with the means for receiving UIDs via short or medium range wireless transmission. The device can have one or more UID itself. Furthermore, such a device may be equipped with a USB port for connecting to a computer, allowing the device to upload its seen logs to the server by using a computer's Internet connection. Alternatively, such a device may also transmit the collected seen log information to a computer, cell phone or PDA using Bluetooth, WLAN, infrared, acoustic coupling, NFC (near field communication), or similar. This device may specifically do without many of the components that would typically be found on portable devices supporting wireless technology. This device may also be considerably smaller in size, as it may do without a screen or keyboard, for example. A device of such an embodiment may or may not send out its one or more own UID via short or medium range wireless transmission.

In a further embodiment, the device used for recording seen logs may be integrated into a wearable device such as a wrist watch. The technical requirements for such a device can be comparatively low when compared to wireless devices such as cell phones or PDAs. This device is equipped with the means for receiving UIDs via short or medium range wireless transmission. The device can have one or more UID itself. Such a device may be equipped with a USB port for connecting to a computer, allowing the device to upload its seen logs to the server by using a computer's Internet connection. Alternatively, such a device may also transmit the collected seen log information to a computer, cell phone or PDA using Bluetooth, WLAN, infrared, acoustic coupling, NFC (near field communication), or similar. This device may specifically do without many of the components that would typically be found on portable devices supporting wireless technology. This device may also be considerably smaller in size, since it may do without a screen and keyboard, for example. A device of such an embodiment may or may not send out its one or more own UID via short or medium range wireless transmission.

In a further embodiment, accessory devices such as a Bluetooth headset may be used by a user to transmit a UID. A user may be able to obtain such a device's UID by connecting it to a computer (e.g. via Bluetooth), for example. Once obtained, the user could provide the UID to the server (via online user account) and benefit from the described server-based functionality.

In a preferred embodiment, certain but not necessarily all devices carry out the described function of scanning for and recording of UIDs sent out via short or medium range wireless transmission as well as the transfer of the resulting seen logs to a server. These devices may contain the necessary instructions for doing so in the form of software or hardware. Such devices may also be referred to as “seeders”, in order to help explain their function better. The term “seeder” may herein be used to refer to a device that actively scans for and records UIDs being transmitted in its range and makes those UIDs available to a server, such as in the form of the described seen logs. Generally, when a server analyses a given seen log, it can find (among further information) the UIDs that have been received (i.e. “seen”) and recorded. Since the server generally associates a recorded UID with that of the recording device, the server can make this association in both directions, such as for providing communication functionality or options thereto (e.g. grouping or listing the corresponding users on a social networking website). This means that a match between two UIDs in one device's seen log may suffice for both users (of those UIDs) to benefit from such server-based functionality. Taken a step further, the server may also associate two recorded UIDs that it finds in a recording device's seen log(s). This may be especially beneficial in cases where the seen log reveals (to the server) that the recording of two such UIDs has occurred in some more or less relevant context, such as in regard to the times and/or locations of the recordings, for example. Consequently, this aspect of the invention may work even when only a portion of the devices are actively scanning for UIDs and recording seen logs, while the users of devices that only send out their UID (without scanning or recording) may benefit from any applicable server-based functionality provided through this aspect of the invention.

In general, a device's seen log can contain and/or otherwise be linked to the UID of the device that recorded it. For example, this can mean that the recording device writes its own UID in the seen log file. It can also mean that the name of the seen log file can contain the recording device's UID in some form. It is also possible, however, that the recording device's UID is only communicated to the server in the process of uploading its seen log. This can hold true both if the device uploads the seen log information directly (GSM, UMTS . . . ) as well as if the seen log information is transferred via a computer, for example. In the latter case, software running on the computer may obtain the device's UID and forward it to the server accordingly.

Encryption may be used for the seen log information and the UIDs in particular, for writing and/or transferring a seen log. For example, a device recording a seen log may store the UIDs in an encrypted or scrambled way, so as to prevent that information from being accessible in undesirable ways (e.g. hackers).

In general, a combination of different types of UIDs may be used for this aspect of the invention. For example, Bluetooth Device Addresses, WLAN MAC addresses and other types of UIDS may all be used by the server to provide the described functionality.

In a further embodiment, the UIDs of devices that have passed into their respective proximities are awaited (by the server) from all involved parties (devices) before being associated. In such a case, a true exchange of UIDs needs to occur before any two UIDs (or the corresponding user accounts) are associated or linked by the server. This may protect against hackers from manipulating online groupings or associations by altering (hacking) a seen log, for example.

In a further embodiment, blacklists containing specific UIDs may be used to eliminate these UIDs from being associated with others. These blacklists may be UID specific, whereby a user may instruct the server and/or his device to ignore certain UIDs. These could be created or updated through a user's user account and/or through his device. Server-based blacklists may also be used for ignoring or blocking UIDs on behalf of more than one (or all) UIDs. This may be beneficial in eliminating spamming and other unwanted behavior.

In a preferred embodiment, a user may open a user account with an online service that has been established in context of this aspect of the invention. Alternatively, this may be an existing online service that has expanded its services accordingly. The user may open such an account through the usual procedure on such services, by providing a name, selecting a user name, etc. However, the service may also allow the user to open a user account solely on the basis of his device's UID. He may add more information such as to create a personal profile (e.g. names, information, photos, etc.), but this can be optional. If the user does not provide any information (other than his UID), the online service may attach generic or some random information to that account's profile. This could include a generic symbol depicting an unknown user. If the user reveals his gender, the depiction could reflect this such as through a silhouette with short or long hair, for example. Once the user has opened his user account by supplying his UID (thereby “claiming” it), he may begin using the server-based functionality.

In a further embodiment, users are not required to open user accounts in a formal, conventional sense. As soon as the server receives a device's UID, a UID account is automatically generated. Such a UID account may also be opened by a user who supplies his device's UID, such as through a webpage by the online service. If his device's UID is already known to the server (such as through another device's seen log), the user could begin using it by “claiming” it. His account may already hold information by that time.

In a preferred embodiment, a device sends out its UID via short or medium range radio frequency signals, while at the same time scanning for UIDs transmitted by further devices. Upon reception of a UID, the device immediately sends that UID, together with its own UID, to a server (e.g. via GSM, UMTS, WLAN, etc.). The server then associates those UIDs to provide online communication or options thereto. If the users of two such associated UIDs connect (or always are connected) to that server, then those users will be able to communicate using any service the server provides between its UID accounts. For example, users could be connected through a web interface or browser directly on the devices which exchanged the UIDs. However, the users could also log-on to their user accounts (or UID accounts) using any other device that is or can connect to the Internet (e.g. PDA, Laptop, etc.). Depending on the information and settings supplied by each user in his user account (e.g. profile), the server may also allow such a user to view further information on the other user. More specifically, this could include names, nicknames, logos, pictures, phone numbers, cell phone numbers, e-mail or instant messaging addresses, etc., for example. Furthermore, the server may also itself provide messaging services such as e-mail, push e-mail, instant messaging, VolP, etc. These could be used in accordance to individual user choices. Through such a mobile connection to his user account, the user may also decide to allow, block or always block specific users. As such, users may come into contact electronically by having their UIDs exchanged automatically via short or medium range wireless technology (e.g. Bluetooth, WLAN, etc.), while at the same time staying in control of their personal contact information. This further allows a user to communicate with strangers on his terms and only for as long as he so desires. By combining this embodiment with the described seen list functionality, the online service may further improve the value provided to users by ranking and structuring the users based on factors such as lengths, frequencies and locations of the UID receptions (or UID exchanges). For example, this could let a user decide that people he spends a lot of time being close to should be allowed to contact him in certain (perhaps more intrusive) ways as others.

According to the present invention, the first, second and third aspect of the invention can be combined. Accordingly, preferred embodiments of the first, second and third aspect can be combined to give preferred embodiments of a fourth aspect of the present invention.

For example, according to a combination of the first and third aspect, the present invention is directed according to a fourth aspect to a device for establishing contact wirelessly with a second compatible device, comprising:

means (a), to automatically establish non-directional contact as well as the transfer of one or more first data packets between the device and one or more target device(s); and

means (b), which, following an automatic, non-directional contact as well as the transfer of one or more first data packets between the device and one or more target devices, allows the user to transfer one or more directional second data packets, wherein

the device is a portable electronic device
(a) transmitting continuously/repeatedly one or more unique identifiers
(UID) via non-directional wireless radio frequency signals; and
(b) scanning continuously/repeatedly for UIDs sent out by other devices of its type.

The inventive device and the inventive method, in particular of the first and second aspect, offer several advantages. These include the ability to make contact with nearby persons (with compatible devices). Applications can include being able to address individuals who are otherwise unknown, such as in outdoor places, on public transportation, public events, etc.

Upon reception of data, any recipient may reply, provided he is within range, according to the transmission path used. This may include text, pictures, video, etc., as well. This may, however, occur only via the same communication path, so long as the other party has not transmitted further contact data. This provides a way for users to communicate electronically with others nearby, and can be specifically confined to a level which does not require users to share personal contact information, such as phone numbers or conventional electronic addresses.

An advantage of the present invention is that college students may for example be able to find peers on a social networking site without having to know their names or electronic addresses. Simply spending time in the same room or area, users may subsequently find on an Internet portal those whom they were near in the real world.

In a preferred embodiment, the server generates views displaying the individuals a user has been close to. Furthermore, the server can structure the view in such a way that the user is able to identify whom he or she has been near to most often, spent the most time with, as well as combinations thereof.

For example, fellow students may be more likely to want to interact with each other online than two users who just happen to have spent time near each other one on a train ride. Therefore, users who have met more frequently may be listed higher up on each others' lists.

Applications include social networking sites, access to Internet forums, blogs, etc.

A device, receiving another device's UID, measures the length of time it continues to receive that UID. Once the UID is no longer received (or a variable duration thereafter), the first device stores the event in a log, including the received UID, length of reception as well as the time, date and location (if available). Information regarding a device's location may be obtained from cell-IDs on some mobile networks or through the help of a GPS signal, for example.

Such functions can include generating individual groups or social networks consisting of members whose UIDs appear in a given user's seen log.

Optionally, the server may require the exchanged UIDs to be present in the seen logs of all involved parties, leading to groups of users who all know or have “seen” one another.

If the time of a renewed reception of a UID lies within a pre-defined or user-selectable span of time, the device may store the event in its log as if the interruption had not occurred.

The event that the second device's UID is received again by the first device may be referred to herein as a “resumed session”. Depending on the amount of time that has elapsed between the end of a seen session and the beginning of a resumed session, the first device may write in its log one of two things:

In the event that the time between sessions is rather long, the log may reflect a new session. In the event that the time between sessions is rather brief, the log may reflect the continuation of the previous session.

This may offer two advantages: the first is that it represents a means to compensate for brief interruptions in the transmissions of the UIDs due to technical limitations of the devices or interferences, for example. The second advantage is that under certain circumstances, a more useful log may be generated.

A first device preferably continually transmits its at least one unique identifier. The device also continually scans for transmitted identifiers by other devices in its range. When a second device's identifier is first received, the device stores the event in a “seen log” together with the second device's identifier and a time and date stamp. When the first device stops receiving the second device's identifier (for a specified amount of time), it stores that event in its “seen log” along with a time and date stamp.

If the first device again receives the second device's identifier, the first device again stores the event in its “seen log” with a time and date stamp.

Optionally, if the time between the last reception and the renewed reception of the same identifier falls within a specified amount of time, the device may adjust the event and prolong the ‘seen’ session in the log.

A portable electronic device is equipped with an optional mode and the means to continuously or repeatedly transmit at least one unique identifier (UID) via short or medium range wireless radio. Furthermore, the device scans continuously for UIDs transmitted by compatible devices. The device is also able to store in a “seen log” the UIDs it has received as well as the date, time and duration of the receptions. The information from the seen log is transmitted to a server, which in turn is thereby able to provide one or more services via user accounts which are linked to the corresponding UIDs.

It can be of particular interest for younger people, such as students, to be able to communicate electronically with persons, whom they share the same school with. It may also be useful for users attending sporting or musical events, clubs, restaurants, etc., for example.

Furthermore, by analyzing the devices' seen logs the server is able to make assumptions regarding which users may know one other or who may be more likely to want to get to know one other. The server can evaluate the information from the logs in regard to how often and for what duration any two devices were near each other.

This aspect of the invention provides a means for individuals to get to know others with whom they have shared the same locality, but for whatever reason were not able to make contact directly. Particularly young people are often able to overcome personal inhibitions or shyness when communicating electronically, as opposed to in person, especially in the presence of others.

Furthermore, it appears advantageous to link users on the basis of their normal real-life whereabouts and daily encounters for online activities such as server-based social networking.

It is an advantage of the present invention that communication layers, through the help of which users may come into contact with one another on the basis of past and/or present proximities in relation to one another, allow the provision of an alternative to the disclosure of personal contact information that is typically required for electronic communication.

### SPECIFIC EXAMPLES

Turning to the figures, representative examples are described next:

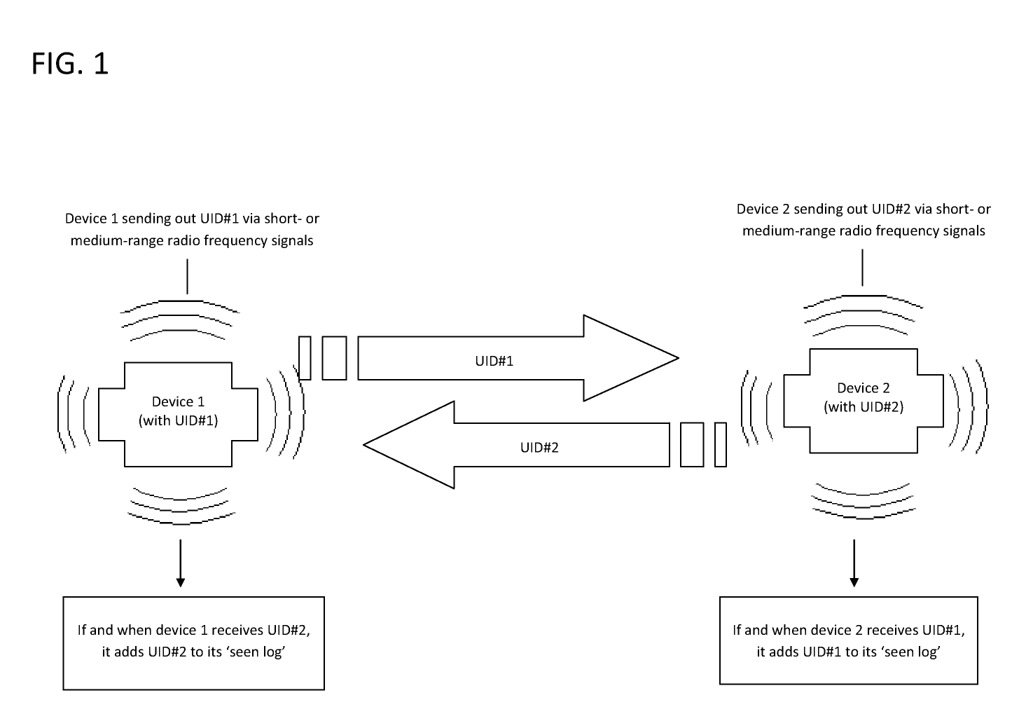

FIG. 1 shows a schematic diagram of two devices sending out UIDs. Device 1 sends out UID#1 and device 2 sends out UID#2. If and when device 1 receives UID#2, device 1 stores UID#2 in its seen log. If and when device 2 receives UID#1, device 2 stores UID#1 in its seen log.

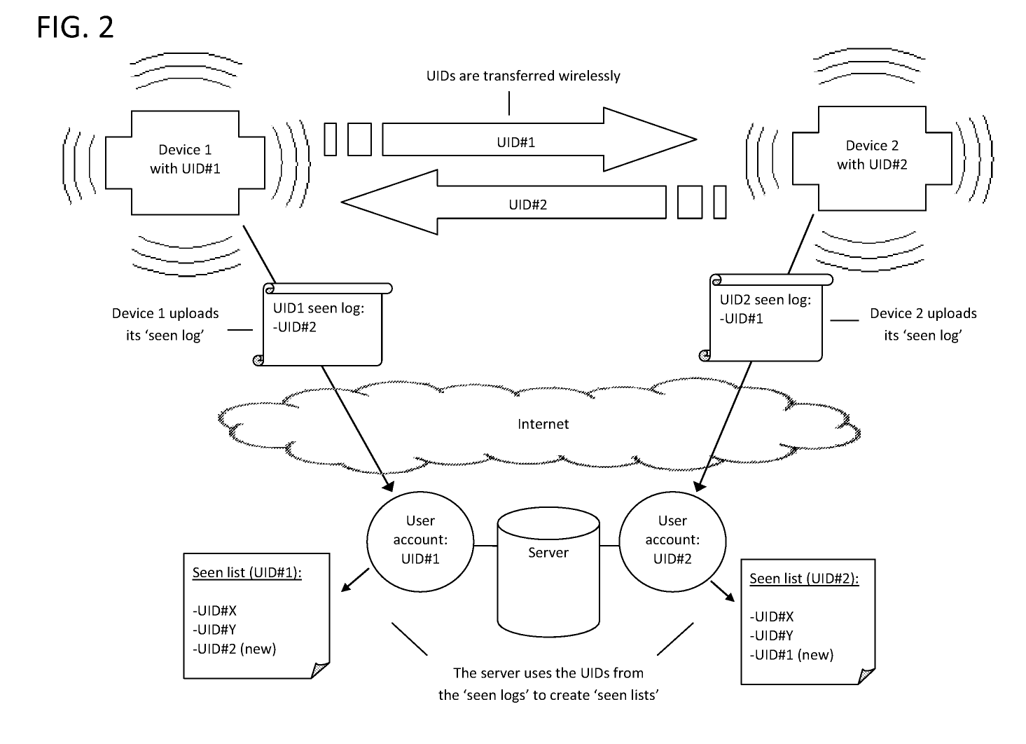

FIG. 2 shows a schematic diagram of two devices sending out UIDs with the assumption that both UIDs in FIG. 1 were exchanged. FIG. 2 shows device 1 uploading its seen log to a server. The server adds the seen log information to a seen list in the UID#1 user account. FIG. 2 also shows device 2 uploading its seen log to the server. The server adds the seen log information to a seen list in the UID#2 user account.

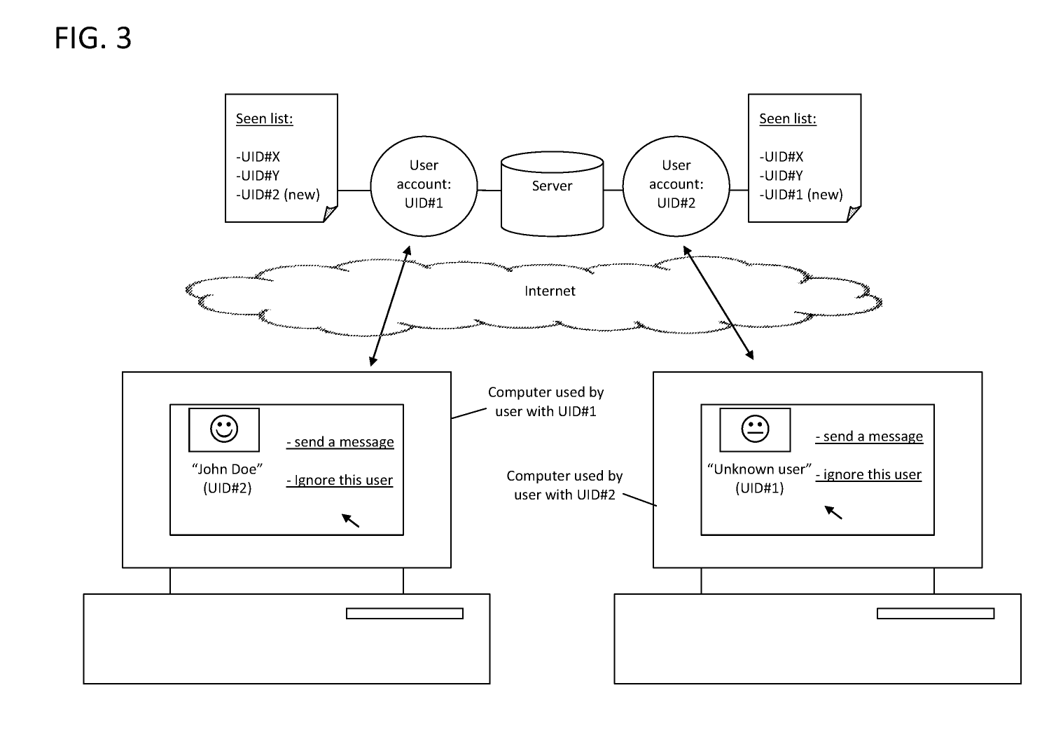

FIG. 3 shows an example of optional communication provided by the server, on the basis of the uploaded seen logs in FIG. 2. Shown are two computers from which the user accounts corresponding to UID#1 and UID#2 are being accessed (not necessarily simultaneously). In this example, both users are given the option of sending a message to the new person on their seen list.

Both users are also given the choice of ignoring that new person on their seen list. In this example, the user of UID#2 has personalized his user account to display the name “John Doe”. The user of UID#1 has not personalized his or her user account, resulting in other users seeing his status as an “Unknown user”. Regardless of this circumstance, the user of UID#2 may still send a message to the “Unknown user”.

1. A portable electronic device, comprising
means (c) for scanning continuously/repeatedly for UIDs sent out by other devices and recording these UIDs in a log; and
means (d) for transferring the recorded UIDs to a server or another electronic device (f).

2. Device according to claim 1, wherein the device contains means (e) for transmitting continuously/repeatedly one or more unique identifiers (UID) via non directional wireless radio frequency signals.

3. Device according to claim 1 or 2, wherein the server or other device (f) stores received UIDs in a ‘seen list’, together with the time, date and duration of the reception.

4. Device according to any of claims 1 to 3, wherein the device's location at the time of a reception (of a UID) is stored.

5. Device according to any of claims 1 to 5, wherein the other electronic device is a personal computer.

6. Device according to any of claims 1 to 5, wherein the server comprises means to generate a list of persons whom a user has been near.

7. A method for establishing server-based communication options, whereby:
(g) portable electronic devices containing identifiers (UIDs) record identifiers that are transmitted wirelessly and non-directionally by other portable electronic devices,
(h) the identifiers (UIDs) are transferred to a server, and
(i) the identifiers (UIDs) are used by a server to provide communication between users of the devices containing the, identifiers that have been recorded.

8. Method according to claim 7, whereby the identifiers include Bluetooth Device Addresses, portions thereof and/or Bluetooth Friendly Names.

9. Method according to claim 7 or 8, whereby the identifiers include WLAN MAC addresses.

10. Method according to any of claims 7 to 9, whereby a server structures the data received from the device (s) in the form of “seen lists”.

11. Method according to any of claims 7 to 10, whereby the recorded identifiers are transferred to a server by way of another device, such as a computer with Internet access.

12. Method according to any of claims 7 to 10, whereby the recorded identifiers are transferred to a server by the recording device.

13. A device for establishing contact wirelessly with a second compatible device, comprising:
means (a) for automatically establishing non-directional contact as well as the transfer of one or more first data packets between the device and one or more target device(s); and
means (b), which (following an automatic, non-directional contact as well as the transfer of one or more first data packets between the device and one or more target devices) allows the user to transfer one or more directional second data packets.

14. A method for establishing contact wirelessly between the inventive device and at least one target device, whereby:
means (a) automatically establish non-directional contact as well as transfer one or more first data packets between the device and one or more target device(s), and
means (b) after automatically and non-directionally establishing contact and transferring one or more first data packets between the device and one or more target device(s), transfer one or more second data packets, directed and controllable by the user of the device.
